(19) United States
(12) Patent Application Publication
(10) Pub. No.: US 2024/0399177 A1
(43) Pub. Date: Dec. 5, 2024

(54) PROTECTIVE DEVICE AND PORTABLE POWERED AIR-PURIFYING RESPIRATOR THEREFOR

(71) Applicant: TECMEN ELECTRONICS CO., LTD, Nanjing, Jiangsu (CN)

(72) Inventor: Ziqian Wu, Nanjing (CN)

(21) Appl. No.: 18/686,383

(22) PCT Filed: Aug. 23, 2022
(86) PCT No.: PCT/CN2022/114157

§ 371 Date: Feb. 23, 2024

(30) Foreign Application Priority Data
Aug. 24, 2021 (CN) 202110973189.2

(51) Int. Cl. A62B 9/04; A62B 7/10; A62B 18/04

(52) U.S. Cl. CPC A62B 9/04; A62B 7/10; A62B 18/045

(57) ABSTRACT

The present application discloses a portable powered air-purifying respirator assembly, comprising: a powered air-purifying respirator; a belt; and a shoulder strap having a casing which is releasably connectable to the belt, the shoulder strap being releasably connectable to the belt, wherein the shoulder strap is connected with a dragging strap, the drawing is provided with a joint through which the shoulder strap is releasably coupled to the casing independently. The present application also discloses a protective device equipped with the portable powered air-purifying respirator assembly.

### CROSS REFERENCE TO RELATED APPLICATIONS

This application is a 371 National Stage of International Application No. PCT/CN2022/114157, filed Aug. 23, 2022, which claims priority to Chinese Patent Application No. 202110973189.2, filed Aug. 24, 2021, the disclosures of which are herein incorporated by reference in their entirety.

### TECHNICAL FIELD

The present application generally relates to a powered air-purifying respirator assembly, especially a portable powered air-purifying respirator assembly which is wearable by a user. The present application also relates to a protective device equipped with the portable powered air-purifying respirator assembly.

### BACKGROUND

In a poor working environment (such as filled with dusts or harmful gases), workmen have to wear a breathing mask on their face such that they can work safely. The breathing mask is coupled to an air-filtering device. For instance, on an outbreak detection site (or on a novel coronavirus detection site), a staff has to wear a full body protection clothing or a breathing mask on his/her face. Then, filtered air is supplied to the interior of the protection clothing or breathing mask by the air-filtering device worn by the staff, such that he/she can work normally in isolation from novel coronavirus.

Conventionally, the air-filtering device configured to supply the filtered air is usually releasably fitted onto a belt fastened or tied around the workman's or staff's waist. For example, the air-filtering device can be fitted onto the belt near the workman's or staff's back. The air-filtering device can be called as a powered air-purifying respirator. As the air-filtering device has to be equipped with some necessary parts such as an electric motor, an air filter, a battery or the like, the device is heavy. Therefore, when the air-filtering device is fitted onto the belt, the device's total weight will be borne by the belt. After a long working term, the workman or staff will feel very tired such that the efficiency of their work will be negatively affected or even an unnecessary accident can occur.

Furthermore, the powered air-purifying respirator is conventionally secured on the belt only. A securing point exists only between the powered air-purifying respirator and the belt. In this case, if the securing point is impaired after long-term usage of the respirator, the powered air-purifying respirator is most likely unexpectedly separated from the belt when the workman or staff is working, which will cause them to breathe unfiltered air and thus result in a safety accident.

### SUMMARY

The present application is aimed at proposing a novel powered air-purifying respirator assembly so as to increase weight-bearing points of a powered air-purifying respirator relative to a user's body and thus alleviate the load on the waist of the user such that work efficiency and safety performance can be improved.

According to one aspect, the present application proposes a portable powered air-purifying respirator assembly, comprising: a powered air-purifying respirator; a belt; and a shoulder strap, the powered air-purifying respirator having a casing which is releasably coupled to the belt, the shoulder strap being releasably coupled to the belt, wherein the shoulder strap is connected with a dragging strap, the dragging strap is provided with a joint through which the shoulder strap is releasably coupled to the casing independently of the belt. Therefore, according to the present application, the powered air-purifying respirator is configured to be coupled to both of the belt and the shoulder strap, increasing weight-bearing points for the portable powered air-purifying respirator assembly when being worn by a user. In this way, the load on the waist of the user can be alleviated so as to improve his/her work efficiency. Furthermore, as the powered air-purifying respirator is secured relative to the user's body also by the shoulder strap, a risk that the powered air-purifying respirator unexpectedly falls due to invalid connection at the waist and thus the user is damaged by breathing harmful environmental gases can be reduced.

In an embodiment, the joint includes a first insertion segment and a second strap hanging segment, the second strap hanging segment is coupled to the dragging strap, and the casing is formed with a slot into which the first insertion segment is insertable and lockable. A length of the dragging strap is adjustable so as to ensure that when the portable powered air-purifying respirator assembly is worn, the dragging strap can be used to always apply a force onto the joint, by which force the powered air-purifying respirator can be dragged upwards so as to alleviate the load on the shoulder of a user who is wearing the portable powered air-purifying respirator assembly.

In an embodiment, the first insertion segment has an insertion end, a resilient tongue is provided at the insertion end, and the slot of the casing has a feature which is configured to engage the resilient tongue so as to lock the first insertion segment in the slot in place.

In an embodiment, the resilient tongue extends from the insertion end in a direction opposite a direction in which the insertion segment can be inserted into the slot, and except for at the insertion end, a gap is formed between the resilient tongue and the first insertion segment such that the resilient tongue can be freely deflected outwards relative to the remaining part of the first insertion segment spaced by the gap.

In an embodiment, the casing has a surface facing the belt, and the slot is formed adjacent to the surface.

In an embodiment, the resilient tongue has a stepped free edge, and the feature of the slot is configured as an aperture formed in the surface in communication with a hollow interior of the slot. The step of the free edge engages an edge of the aperture when the first insertion segment is locked in the slot. Therefore, the first insertion segment is prevented from unexpectedly withdrawing from the slot. The free edge is spaced from the first insertion segment by the gap.

In an embodiment, the aperture is circle-shaped, and the step of the free edge extends as part of a circle.

In an embodiment, the first insertion segment is configured such that it is deflected relative to the second strap hanging segment by a non-zero angle.

In an embodiment, when the surface of the casing is in contact with the belt, the second strap hanging segment is kept away from the belt due to the existence of the non-zero angle.

According to another aspect, the present application proposes a protective device, comprising: a protective mask; a portable powered air-purifying respirator assembly as previously recited; and a connection hose, wherein a powered air-purifying respirator of the portable powered air-purifying respirator assembly comprises an air outlet port which is in air-tight communication with the protective mask via the connection hose.

Using the inventive measures, the powered air-purifying respirator can be readily suspended relative to the body of a user so as to alleviate the load on the user who is working and to improve his/her work efficiency. Furthermore, as the powered air-purifying respirator is coupled to both of the belt and the shoulder strap, such design of multi couplings can minimize the possibility that the powered air-purifying respirator is damaged due to unexpected releasing of the belt from the user's body or unexpected uncoupling of the powered air-purifying respirator from the belt. Therefore, user accidents caused by the damaged powered air-purifying respirator under poor working conditions can be avoided.

### BRIEF DESCRIPTION OF THE DRAWINGS

The principle and other aspects of the present application can be well understood by the following description in combination with the attached drawings. It should be noted that for illustrative purpose only those drawings may be given in different ratios. In the drawings:

FIG. 1 is a view schematically illustrating a portable powered air-purifying respirator assembly according to an embodiment of the present application, in which the portable powered air-purifying respirator assembly has been worn by a user;

FIG. 2 is a perspective view schematically illustrating an example of a shoulder strap of the portable powered air-purifying respirator assembly;

FIG. 3 is a perspective view schematically illustrating an example of a belt of the portable powered air-purifying respirator assembly;

FIGS. 4A and 4B are views schematically illustrating how a joint of the shoulder strap of the portable powered air-purifying respirator assembly is snapped into a casing of a powered air-purifying respirator, respectively; and

FIGS. 5A, 5B and 5C are views schematically illustrating how the joint of the shoulder strap of the portable powered air-purifying respirator assembly is released from the casing of the powered air-purifying respirator, respectively.

### DETAILED DESCRIPTION OF EMBODIMENTS

In the drawings, those features having the same or similar configuration or function are represented by the same reference numerals respectively.

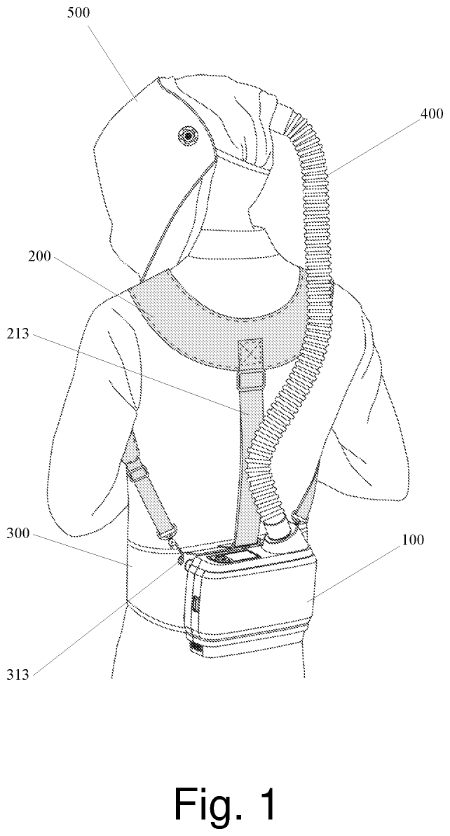

FIG. 1 is a view schematically illustrating a portable powered air-purifying respirator assembly according to an embodiment of the present application. The portable powered air-purifying respirator assembly is shown to be worn by a user. The portable powered air-purifying respirator assembly generally comprises a powered air-purifying respirator 100, a shoulder strap 200 and a belt (or alternatively called as a waist belt) 300.

As an example, the powered air-purifying respirator 100 can comprise a casing 110. Installed in an hollow interior of the casing 110 are necessary constituent parts (not shown) of the powered air-purifying respirator such as an air filter, an electric blower, an electrical power for driving the electric blower, or the like. For instance, the electrical power can be a battery. The powered air-purifying respirator 100 is configured such that when the electric blower operates, air can be sucked into the interior of the casing 110 through an air inlet (not shown) provided in the casing 110, is filtered through the air filter, and then is discharged out of the powered air-purifying respirator. To this end, an air outlet port 120 is provided in the casing 110 of the powered air-purifying respirator 100. The air outlet port 120 is configured to be coupled to a connection hose 400 by which filtered air can be conveyed outside such that the filtered air can be conveyed into a protective mask 500 which is worn on a face of the user. It is conceived by a person skilled in the art that in an alternative embodiment, the filtered air can be conveyed by the hose 400 to a protective clothing worn by the user such that a positive pressure can be generated in a hollow interior of the protective clothing so as to urge air from therein outside, and thus the health and safety of the user can be guaranteed like under novel coronavirus detection and/or therapy scenarios.

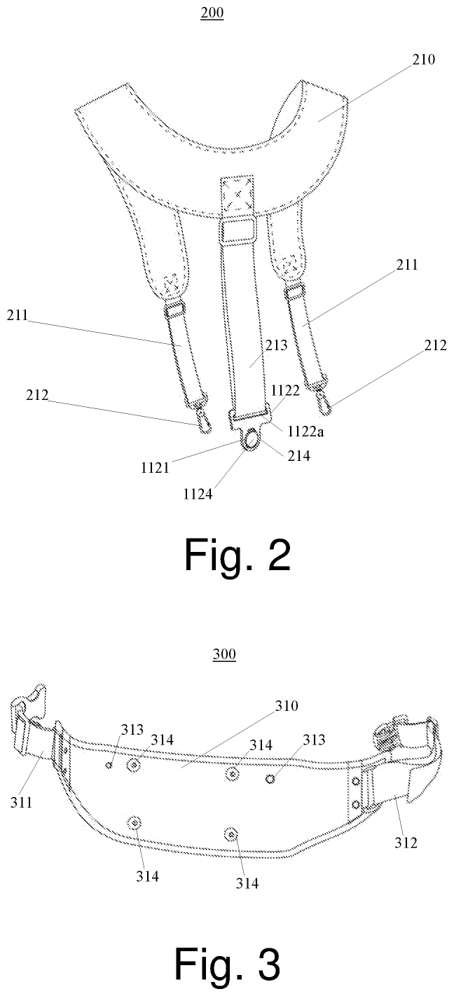

As shown by FIG. 2, the shoulder strap 200 generally comprises a shoulder strap body 210 made of a flexible material. The shoulder strap body 210 is configured to be worn on the shoulder of a user. The shoulder strap body 210 is generally curved and elongated such that it can be worn on the shoulder of users of different sizes. Each of opposing ends of the shoulder strap body 210 is coupled with a connection band 211 whose length is adjustable. For example, the connection bands are sewn onto the opposing ends of the shoulder strap body 210 respectively. The length adjustment of the connection band 211 can be carried out in a suitable manner well known by a person skilled in the art. Each connection band 211 is provided with a buckle 212 by which the band can be releasably attached to the belt 300.

As shown by FIG. 3, the belt 300 generally comprises a belt body 310. For example, the belt body can be made of a material harder than the shoulder strap such that the belt is strong enough to support or be supported by the waist of a user. The belt body 310 is generally strip-shaped and narrows from the middle toward both ends. Two belt connecting sections 311, 312, whose length is adjustable, are coupled to opposing ends of the belt body 310 respectively. Each of the two belt connecting sections 311, 312 is provided with a clip at its free end such that the joints can cooperate with each other. Using the clips, the belt 300 can be tied or fastened around the waist of a user. Furthermore, several matching features 314 (for example, four matching features are shown) are provided in a side of the belt body 310, for example a side departing away from the user when the belt body is being tied or fastened around the waist of the user. The matching features 314 are configured to engage pairing features (not shown) provided on the casing 110 of the powered air-purifying respirator 100 respectively such that the casing 110 of the powered air-purifying respirator 100 is releasably attachable to the belt body 310. For example, those pairing features (not shown) configured to engage the matching features 314 can be formed in a surface 110a of the casing 110. This surface 110a is a surface contacting or facing the belt 300 when the powered air-purifying respirator 100 is coupled to the belt 300. Therefore, the surface 110a can be called as an exposure surface. The matching features 314 and the pairing features can be arranged and/or configured in any suitable manner known by a person skilled in the art.

Additionally, two through holes 313 are formed in the belt body 310 adjacent to an edge thereof. For example, the holes are configured to receive the buckles 212 of the shoulder strap 200 respectively. In the shown embodiment, the two through holes 313 are positioned near the respective matching features 314 such that when the shoulder strap 200 is worn on the shoulder of a user (as shown by FIG. 1), the two connection bands 211 can extend from the front of the user's body to the rear of the user's body and the buckles 212 of them can be received in the through holes 313 of the belt body 310 respectively at the back of the user. In this way, one or more weight-bearing points can be provided for the belt 300 suspended with the powered air-purifying respirator 100 at the waist of the user.

In an alternative embodiment, the through holes 313 as shown can be formed at or near the connection between the belt body 310 and the belt connecting sections 311, 312 respectively such that when the shoulder strap 200 is worn on the shoulder of a user, the two connection bands 211 can be coupled to the belt body 310 directly at the front of a user's body. In another alternative embodiment, the through holes in the belt body 310 as described here can be replaced by buckles provided adjacent to the edge of the belt body 310 and configured to cooperate with the respective buckles 212.

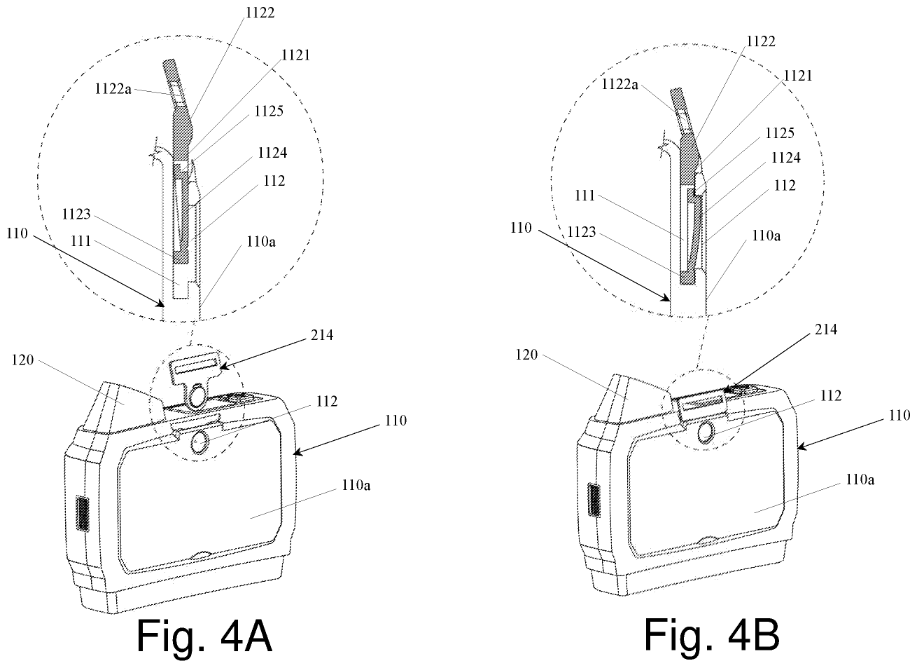

Further as shown by FIG. 2, the shoulder strap body 210 of the shoulder strap 200 also comprises a dragging strap 213. For example, the dragging strap 213 is configured such that its length is adjustable and it has an end sewn onto the shoulder strap body 210. In a preferred embodiment, the dragging strap 213 is sewn to the shoulder strap body 210 at the middle thereof. A free end of the dragging strap 213 is connected with a joint 214 (see FIG. 4). For example, the joint 214 can be made of a hard material like metal, or made of stainless, or a hard plastic material.

As shown by FIG. 4A and FIG. 4B, those dotted circles include sections obtained in a longitudinal direction of the joint 214 (or a direction in which the joint can be inserted into the casing 110) respectively, and exaggeratedly illustrate how the joint 214 is inserted into the casing 110 of the powered air-purifying respirator 100. The joint 214 is generally in the form of a plate and is integrally formed. For example, the joint 214 comprises a first insertion segment 1121 and a second strap hanging segment 1122. The first insertion segment 1121 is insertable and lockable into the casing 110 in a manner as mentioned below. The second strap hanging segment 1122 is connectable with the dragging strap 213. To this end, the second strap hanging segment 1122 is formed with an opening 1122a through which a part of the dragging strap 213 extends such that they can be releasably coupled to each other.

The second strap hanging segment 1122 extends outwards from an end of the first insertion segment 1121, and an opposing end of the first insertion segment 1121 is defined as an insertion end 1123 which is insertable into the casing 110. A resilient tongue 1124 is provided substantially adjacent to the insertion end 1123 and extends towards the second strap hanging segment 1122 such that the resilient tongue 1124 is suspended from the insertion end. Except for a part of the resilient tongue connected to the first insertion segment 1121 substantially adjacent to the insertion end 1123, the resilient tongue is formed such that it is spaced from the first insertion segment 1121 by a gap. In this way, viewed in a section obtained along the longitudinal direction of the joint 214, at least a part of the resilient tongue 1124 can be freely deflected outwards from a main body of the first insertion segment 1121 in absence of an external force applied to the resilient tongue. For example, the resilient tongue 1124 can extend gradually outwards from a location where it is connected to the first insertion segment 1121.

The free deflecting part of the resilient tongue 1124 is used to define a free edge of the resilient tongue 1124 such that a step-shaped free end 1125 is defined at least on a free end of the resilient tongue 1124 longitudinally opposite the insertion end 1123. For example, the free edge of the resilient tongue 1124 is formed as a stepped edge along its circumferential direction. The so-formed step varied in depth which reaches the maximum value at the free end 1225, gradually decreases and finally reaches zero at the connection between the resilient tongue 1124 and the first insertion segment 1121. That is to say, the stepped free end 1125 is defined by the free edge of the resilient tongue 1124.

A slot 111 is formed in the casing 110. In a preferred embodiment, the slot 111 is formed adjacent to the exposure surface 110a. In an alternative embodiment, the slot 111 can be formed apart from the exposed surface 110a in a thickness direction of the casing 110. The slot 111 is formed such that it is able to receive at least the first insertion segment 1121 of the joint 214. As shown by FIGS. 4A and 4B, an aperture 112 is formed in the casing 110, which aperture is in communication with a hollow interior of the slot 111. For instance, the aperture 112 can be formed in the exposure surface 110a. The matching features 314 of the belt 300 and the pairing features of the casing 110 which cooperate with each other can be configured such that when the casing 110 is coupled to the belt 300, an interval space can be left therebetween into which interval space at least one finger of a user is at least partially insertable.

When it is desirable to lock the joint 214 in the casing 110, the insertion end 1123 of the joint 214 is first inserted into the slot 111. In the meanwhile, with the insertion of the insertion end 1123, the resilient tongue 1124 enters the slot 111 with being gradually pressed by an opening edge of the slot 111. Then, with the further insertion of the insertion end 1123 into the slot 111, a region surrounded by the free edge of the resilient tongue 1124 can be exposed through the aperture 112. That is to say, in an opening area of the aperture 112, the resilient tongue 1124 can be deflected outwards again such that the step of the free edge of the resilient tongue 1124 can be snapped on the edge of the aperture 112, as shown by FIG. 4B, for example near the free end 1125. Therefore, the joint 214 can be prevented from being unexpectedly withdrawn from the slot 111, such that the joint 214 is lockable in the casing 110. As the step is snapped on the edge of the aperture 112, a clear sound of “clicking” occurs due to a bounce-back effect of the resilient tongue 1124, which will alter a user to that the resilient tongue 1124 has been locked in place. In addition of or in place of the aperture 112, a feature for cooperating with the resilient tongue can be provided at another part of the slot 111. As an example, such a feature can be a projection formed in an inner wall of the slot 111 such that it is able to engage a part of the resilient tongue 1124, for instance the step of the free edge so as to prevent the first insertion segment from being unexpectedly withdrawn from the slot.

The first insertion segment 1121 and the second strap hanging segment 1122 of the joint 214 are formed such that they are substantially non-coplanar. For instance, in a preferred embodiment, the second strap hanging segment 1122 is formed in such a way that after the first insertion segment 1121 is inserted in the casing 110 and the casing 110 is coupled to the belt 300, the second strap hanging segment 1122 extends, in absence of a dragging force, such that the second strap hanging segment 1122 is deflected apart from the belt 300. In this way, after the second strap hanging segment 1122 is coupled to the dragging strap 213 while the portable powered air-purifying respirator assembly is worn onto a user's body, because the second strap hanging segment 1122 extends relative to the first insertion segment 1121 in such a way that the second strap hanging segment 1122 is deflected apart from the user's body, the first insertion segment 1121 will exert a force to the casing 110, keeping it away from the belt 300, due to such deflection when the second strap hanging segment 1122 is hanging from the dragging strap 213 in the direction of gravity. Therefore, the load applied onto the belt 300 by the coupling between the casing 110 and the belt 300 can be at least partially uploaded, thus reducing the stress transmitted from the belt 300 to the waist of the user, and alleviating the load on the user.

In an embodiment of the present application, the powered air-purifying respirator 100 can be coupled to the belt 300, the belt 300 can be tied around the waist of a user, and the shoulder strap 200 can be coupled to the belt 300 so as to provide an uploading effect and increase weight-bearing points of the powered air-purifying respirator relative to the user's body. At the same time, the powered air-purifying respirator 100 can be also coupled to the dragging strap 213 of the shoulder strap 200 such that the stress burden on the waist of the user caused by the belt 300 due to the coupling between the powered air-purifying respirator 100 and the belt 300 can be alleviated. Therefore, the load on the waist of the user can be greatly alleviated such that the user can work more efficiently and safely.

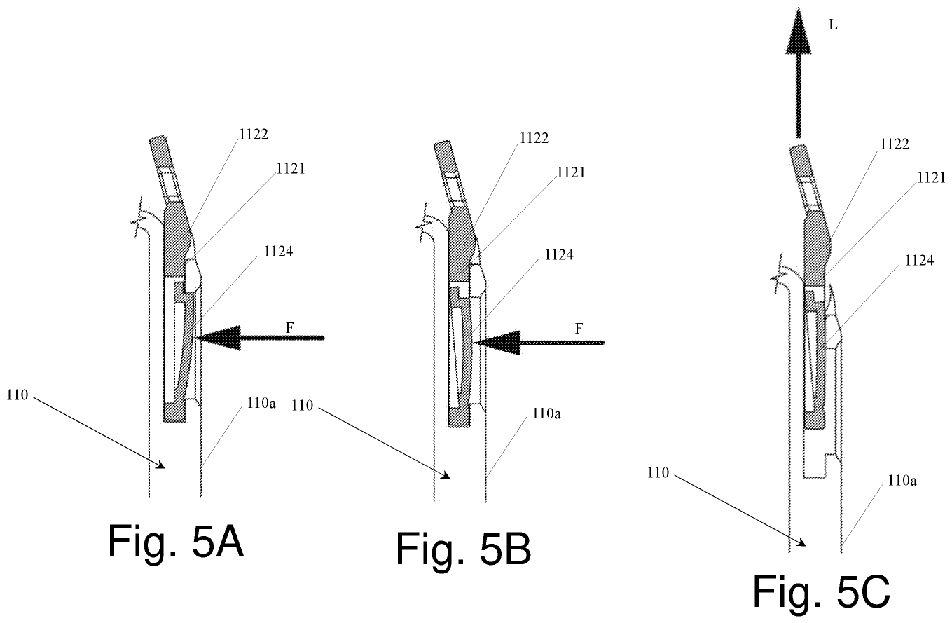

When it is desired to release the joint 214 from the casing 110, as shown by FIGS. 5A to 5C, a user can insert his or her finger into the interval space between the casing 110 and the belt 300 such that a press force can be exerted onto the resilient tongue 1124 as shown by an arrow F to deflect the resilient tongue 1124 inwards, so as to disengage the step of the free edge of the resilient tongue 1124 from the edge of the aperture 112. Then, as indicated by an arrow L of FIG. 5C, pulling the joint 214 will pass the pressed resilient tongue 1124 together with the first insertion segment 1121 of the joint 214 through the opening of the slot 111 and thus withdraw them from the slot 111. As the joint 214 completely leaves the casing 100, the resilient tongue 1124 will be deflected freely outwards again relative to the first insertion segment 1121.

In the shown embodiment, only a single dragging strap 213 is illustrated. However, it should be understood by a person skilled in the art that in an alternative embodiment two or more dragging straps 213 can be adopted such that more force bearing points can be provided for the shoulder of a user so as to alleviate the load on the shoulder of the user. Furthermore, if several dragging straps 213 are provided, each of them can be equipped with a joint 214 as shown; or alternatively, the dragging straps 213 can be connected with only one joint 214.

In the shown embodiment, the aperture 112 is formed to be substantially circle-shaped; correspondingly, the resilient tongue 1124, particularly its free edge is also substantially circle-shaped. Therefore, if the interior space of the slot 111 is large, the first insertion segment 1121 can be designed such that after it is inserted in the slot 111 while the resilient tongue 1124 engages the aperture 112 by its free edge, the first insertion segment 1121 is at least partially pivotable about the free edge of the resilient tongue 1124. In this way, even if the belt 300 is obliquely tied around the waist of a user, the powered air-purifying respirator 100 hanging from the dragging strap 213 via the joint 214 can adapt to gravity in an optimal orientation such that the dragging strap 213 is pulled as straightly as possible so as to improve the wearing comfort of the portable powered air-purifying respirator assembly.

In a preferred embodiment, the first insertion segment 1121 and the second strap hanging segment 1122 of the joint 214 together are substantially T-shaped. A vertical section of the T is defined by the first insertion segment 1121, and a cross section of the T is defined by the second strap hanging segment 1122 such that after the first insertion segment 1121 is completely inserted in the slot 111 and locked therein, the second strap hanging segment 1122 can seat against or adjacent to the opening of the slot 111 so as to secure the joint 214 more stably.

Although in the shown embodiment the joint 214 is in the form of a plate, the joint can be formed in any other suitable shape in an alternative embodiment. For instance, the first insertion segment can be pillar-shaped or rod-shaped. Furthermore, in an alternative embodiment, the joint coupled to the dragging strap 213 can be configured to have the slot and/or relevant features and the casing 110 can be provided with the first insertion segment 1121 and/or relevant features.

It should be understood that the protective mask 500, the portable powered air-purifying respirator assembly, and the connection hose 400 as described can constitute a protective device in which the air outlet port 120 of the powered air-purifying respirator 100 of the portable powered air-purifying respirator assembly is air-tightly connectable to the protective mask 500 via the connection hose 400. Here, the protective mask can be a breathing mask or any other suitable mask necessary for being worn by a user in situations where breathing is not safe.

Although some specific embodiments and examples of the present application have been described here, they are given for illustrative purposes only and cannot be construed to limit the scope of the present application. Furthermore, it should be understood by a person skilled in the art that the embodiments and examples described here can be arbitrarily combined with each other. Without departing from the spirit and scope of the present application, various modifications, alternations and replacements can be thought out.

1-10. (canceled)

11. A portable powered air-purifying respirator assembly, comprising:
a powered air-purifying respirator;
a belt; and
a shoulder strap, the powered air-purifying respirator having a casing which is releasably coupled to the belt, the shoulder strap being releasably coupled to the belt, wherein the shoulder strap is connected with a dragging strap, the dragging strap is provided with a joint through which the shoulder strap is releasably coupled to the casing independently.

12. The portable powered air-purifying respirator assembly as recited in claim 11, wherein the joint includes a first insertion segment and a second strap hanging segment, the second strap hanging segment is coupled to the dragging strap, and the casing is formed with a slot into which the first insertion segment is insertable and lockable.

13. The portable powered air-purifying respirator assembly as recited in claim 12, wherein the first insertion segment has an insertion end, a resilient tongue is provided at the insertion end, and the slot of the casing has a feature which is configured to engage the resilient tongue so as to lock the first insertion segment in the slot in place.

14. The portable powered air-purifying respirator assembly as recited in claim 13, wherein the resilient tongue extends from the insertion end in a direction opposite a direction in which the insertion segment can be inserted into the slot, and except for at the insertion end, a gap is formed between the resilient tongue and the first insertion segment such that the resilient tongue can be freely deflected outwards relative to a part of the first insertion segment spaced by the gap.

15. The portable powered air-purifying respirator assembly as recited in claim 14, wherein the casing has a surface facing the belt, and the slot is formed adjacent to the surface.

16. The portable powered air-purifying respirator assembly as recited in claim 15, wherein the resilient tongue has a stepped free edge, the feature of the slot is an aperture formed in the surface in communication with a hollow interior of the slot, and the step of the free edge is configured to engage an edge of the aperture when the first insertion segment is locked in the slot, so as to prevent the first insertion segment from unexpectedly withdrawing from the slot.

17. The portable powered air-purifying respirator assembly as recited in claim 16, wherein the aperture is circle-shaped, and the step of the free edge extends as part of a circle.

18. The portable powered air-purifying respirator assembly as recited in claim 15, wherein the first insertion segment is configured such that it is deflected relative to the second strap hanging segment by a non-zero angle.

19. The portable powered air-purifying respirator assembly as recited in claim 16, wherein the first insertion segment is configured such that it is deflected relative to the second strap hanging segment by a non-zero angle.

20. The portable powered air-purifying respirator assembly as recited in claim 17, wherein the first insertion segment is configured such that it is deflected relative to the second strap hanging segment by a non-zero angle.

21. The portable powered air-purifying respirator assembly as recited in claim 18, wherein when the surface of the casing is in contact with the belt, the second strap hanging segment is kept away from the belt due to the existence of the non-zero angle.

22. The portable powered air-purifying respirator assembly as recited in claim 19, wherein when the surface of the casing is in contact with the belt, the second strap hanging segment is kept away from the belt due to the existence of the non-zero angle.

23. The portable powered air-purifying respirator assembly as recited in claim 20, wherein when the surface of the casing is in contact with the belt, the second strap hanging segment is kept away from the belt due to the existence of the non-zero angle.

24. A protective device, comprising:
a protective mask;
a portable powered air-purifying respirator assembly, including:
a powered air-purifying respirator;
a belt; and
a shoulder strap, the powered air-purifying respirator having a casing which is releasably coupled to the belt, the shoulder strap being releasably coupled to the belt, wherein the shoulder strap is connected with a dragging strap, the dragging strap is provided with a joint through which the shoulder strap is releasably coupled to the casing independently; and
a connection hose, wherein the powered air-purifying respirator of the portable powered air-purifying respirator assembly comprises an air outlet port which is in air-tight communication with the protective mask via the connection hose.

25. The protective device as cited in claim 24, wherein the joint includes a first insertion segment and a second strap hanging segment, the second strap hanging segment is coupled to the dragging strap, and the casing is formed with a slot into which the first insertion segment is insertable and lockable.

26. The protective device as cited in claim 25, wherein the first insertion segment has an insertion end, a resilient tongue is provided at the insertion end, and the slot of the casing has a feature which is configured to engage the resilient tongue so as to lock the first insertion segment in the slot in place.

27. The protective device as cited in claim 26, wherein the resilient tongue extends from the insertion end in a direction opposite a direction in which the insertion segment can be inserted into the slot, and except for at the insertion end, a gap is formed between the resilient tongue and the first insertion segment such that the resilient tongue can be freely deflected outwards relative to a part of the first insertion segment spaced by the gap.

28. The protective device as cited in claim 27, wherein the casing has a surface facing the belt, and the slot is formed adjacent to the surface.

29. The protective device as cited in claim 28, wherein the resilient tongue has a stepped free edge, the feature of the slot is an aperture formed in the surface in communication with a hollow interior of the slot, and the step of the free edge is configured to engage an edge of the aperture when the first insertion segment is locked in the slot, so as to prevent the first insertion segment from unexpectedly withdrawing from the slot.

30. The protective device as cited in claim 29, wherein the aperture is circle-shaped, and the step of the free edge extends as part of a circle.
